(19) United States
(12) Patent Application Publication
(10) Pub. No.: US 2009/0047572 A1
(43) Pub. Date: Feb. 19, 2009

(54) CONTROLLED PRESSURE RELEASE FOR PACKAGED BATTERIES AND ASSOCIATED SYSTEMS AND METHODS

(75) Inventors: Rory Pynenburg, Ridgefield, WA (US); Jeff Van Zwol, Portland, OR (US)

Correspondence Address: PERKINS COIE LLP;PATENT-SEA, P.O. BOX 1247, SEATTLE, WA, 98111-1247, US

(73) Assignee: MicroPower Electronics, Inc., Beaverton, OR (US)

(21) Appl. No.: 12/193,481

(22) Filed: Aug. 18, 2008

Related U.S. Application Data
(60) Provisional application No. 60/956,288, filed on Aug. 16, 2007.

(51) Int. Cl. H01M 2/10; H01M 6/00

(52) U.S. Cl. 429/100; 29/623.2

(57) ABSTRACT

A battery package for providing power to an electronic device is described herein. In one embodiment, the battery package includes a casing configured to enclose at least one battery cell. The casing includes a wall having an internal surface, an external surface and a dimple. The dimple extends outward from the internal surface to an intermediate section of the wall. In a particular embodiment, the dimple is positioned to rupture under high pressure conditions and direct escaping gases away from selected components of the electronic device in which the battery package is housed.

### CROSS-REFERENCE TO RELATED APPLICATION

This application claims the benefit of U.S. Provisional Patent Application No. 60/956,288 filed Aug. 16, 2007, entitled “CONTROLLED PRESSURE RELEASE FOR PACKAGED BATTERIES AND ASSOCIATED SYSTEMS AND METHODS,” which is incorporated herein by reference in its entirety.

### TECHNICAL FIELD

The present disclosure is related to packaged battery devices and methods of manufacturing such devices.

### BACKGROUND

Many portable electronic devices employ a battery package in lieu of conventional batteries or conventional battery arrangements. Existing battery packages are rechargeable and customizable, and typically include an array of rechargeable battery cells, circuitry for monitoring and regulating output power, and a casing that houses the battery cells and battery circuitry. Accordingly, battery packages can be tailored so that the battery cells meet specific power requirements, the package circuitry provides power feedback and control, and the package casing protects the package cells and circuitry from various environmental factors. For example, battery cells for portable medical equipment (e.g., defibrillators, portable X-ray devices, and infusion pumps) are designed to meet stringent power tolerances. The package circuitries for hand-held data collection devices (e.g., barcode scanners, RFID readers, and portable printers) are configured to accommodate usage patterns, and the package casings for field instruments have contact openings that are fitted with Gore-Tex® seals to prevent moisture from entering the battery package.

Despite the foregoing advantages, battery packages are more complex than conventional batteries and can therefore be more prone to failure or diminishing performance. For example, if an individual battery cell fails, this event can cause other battery cells within the package to rapidly discharge, resulting in overheating. If the package circuitry fails, the battery package may stop functioning correctly. If the package casing becomes compromised, moisture or other types of environmental influences may affect battery package performance. Thus, to facilitate battery package operation, battery package designers need to address issues that are not common to conventional batteries and battery arrangements.

### BRIEF DESCRIPTION OF THE DRAWINGS

FIG. 1 is an isometric view of a portable device and a battery package configured in accordance with one embodiment of the disclosure.

FIG. 2A is cross-sectional end view of the battery package of FIG. 1.

FIG. 2B is a cross-sectional side view of the battery package of FIG. 1.

FIG. 2C is an isometric view of an interior portion of the battery package of FIG. 1.

FIG. 3 is an isometric view of a portion of an interior surface of a package casing having an arrangement of dimples in accordance with another embodiment of the disclosure.

FIG. 4 is a cross-sectional view of a package casing in accordance with another embodiment of the disclosure.

FIG. 5 is a cross-sectional side view of a dimple extending into a package casing in accordance with an embodiment of the disclosure.

FIG. 6 is a cross-sectional side view of a dimple extending into a package casing in accordance with another embodiment of the disclosure.

FIG. 7 is an isometric view of a portion of an interior surface of a package casing having an arrangement of grooves in accordance with another embodiment of the disclosure.

### DETAILED DESCRIPTION

Several aspects of the present disclosure are directed to devices and methods for releasing pressure from packaged battery devices in a controlled fashion, for example in a controlled direction. Well-known characteristics often associated with these devices and methods have not been shown or described in detail to avoid unnecessarily obscuring the description of the various embodiments. Those of ordinary skill in the relevant art will understand that additional embodiments may be practiced without several of the details described below, and that other embodiments may include aspects in addition to those described below.

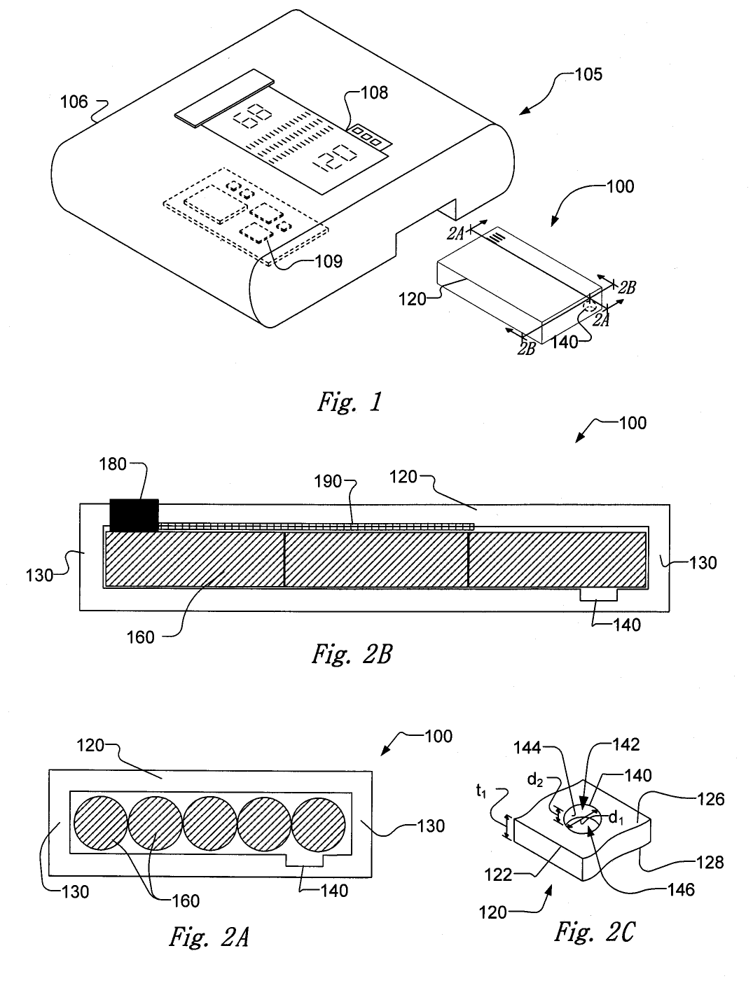

FIG. 1 is an isometric view of a representative embodiment of a battery package 100 that can be operably coupled to a portable device 105. The battery package 100 can include a package casing or shell 120 (e.g., made from molded plastic) that houses one or more battery cells. The casing 120 can further include an internally located dimple 140, blind hole, cavity or other surface depression that extends from an opening in an interior surface of the casing 120 to an intermediate section of the casing 120. The dimple 140 is generally concealed by an exterior surface of the casing 120 (i.e., the dimple 140 is not visible from the exterior surface of the casing 120). The portable device 105 can have a housing body 106 that includes external electronic components 108 (e.g., an LED display and related controls) accessible from an exterior surface of the housing body 106, and internal electronic components 109 (e.g., a printed circuit board, a microelectronic chip, a wire or related signal path, and/or other types of electronic circuitry) disposed within the housing body 106. When the battery package 100 is coupled to provide power to the portable device 105, the dimple 140 is arranged so that it extends in a direction that generally faces away from the electronic components 108-109 and/or other selected portions of the portable device 105. In other embodiments, the dimple 140 can also be arranged to face away from neighboring devices, e.g., other portable devices located external to the case 120.

In a particular embodiment, the package casing 120 allows internal pressures within the casing to be preferentially released and/or equalized at the dimple 140. The dimple 140 can accordingly be configured to be a local weak point in the casing wall that is the first to rupture in the event of a rapid pressure accumulation, such as from a battery cell out-gassing. Battery cell out-gassing or venting can occur when a battery cell is exposed to abusive conditions, and generally results in the emission of gas or vapor. Large amounts of emitted gas can accumulate within the package casing 120, creating a pressure differential at the casing walls. If the pressure differential is sufficiently large, the package casing 120 will preferentially rupture at the dimple 140. The dimple 140 can be positioned so that the escaping gases are directed along a selected vector (e.g., away from selected features) and can therefore mitigate potential damage to the portable device 105 or portions of the device (e.g., the electronic components 108-109).

Unlike conventional battery packages, embodiments of the package casing 120 are equipped to release internally accumulated pressure in a predetermined direction. When undergoing a large pressure differential, conventional battery packages tend to rupture at one or more weak points that may be located randomly in the casing walls, which creates a risk for damage to the portable device in which the battery package is housed. It is generally difficult to design pressure release mechanisms into conventional package casings because such casings should generally be well-sealed. For example, some pressure release mechanisms include an opening with a membrane (made of a material different than that of the casing wall) positioned over or across the opening. Such membranes can be expensive, due to the cost of the membrane material and its installation, and they do not always interface well with package casing material. Accordingly, conventional package casings generally rupture in an uncontrolled manner and/or at uncontrolled locations in the casing. By contrast, embodiments of the dimple 140 are designed to direct rupture gases away from the package casing 120 at a predetermined location and/or in a predetermined direction selected to control, and in some cases eliminate, potential damage to system components. Furthermore, because the dimple 140 does not extend all the way through the casing walls, the release mechanism does not require a secondary material. Instead, in particular embodiments, the package casing 120 can be made from a single homogenous material and the dimple 140 may be made as part of the process of molding the package casing 120. The dimple 140 can also be concealed inside the package casing 120, which can provide for an aesthetically pleasing outward appearance. Further, the dimple 140 can allow the battery package 100 to be used in submersible applications and yet also have a pressure release mechanism. Conventional membrane materials (such as Gore-Tex®) are typically attached to the wall of a battery package casing through the use of adhesives. Such attachments can be compromised during immersion in liquid, allowing the ingress of liquid into the battery package casing. However, unlike a membrane opening, the dimple 140 does not expose internal elements of the package casing 120 to the outside environment. Thus, when the package casing 120 is submersed, liquid cannot easily penetrate the casing and damage electrical components internal to the casing.

As previously described, in particular embodiments, before any rupture occurs in the package casing 120, the dimple 140 is not visible from the exterior of the package casing 120. When a rupture occurs in the package casing 120 at the location of the dimple 140, it can be seen on the exterior of the package casing 120. Because such a rupture is visible, it can be easily ascertained from a visual inspection of the exterior of the package casing 120. Accordingly, such a visual inspection enables a user to determine whether there was a prior accumulation of pressure within the package casing 120 and subsequent release of pressure through the package casing 120 at the dimple 140. Accordingly, embodiments of the dimple 140 enable the user to easily diagnose problems with battery cells 160 within the package casing 120. Because such ruptures would typically impair the integrity of the package casing 120, embodiments of the dimple 140 can be thought of as single-use, i.e., allowing a single instance of pressure release before repair or replacement of the package casing 120 is necessitated. In contrast, conventional membrane openings would allow for multiple instances of pressure release before requiring repair or replacement of the casings carrying them.

Also as previously described, because embodiments of the dimple 140 do not extend all the way through the package casing 120, the package casing 120 has a smooth exterior surface. This may enable an easier or more straightforward manufacturing process for the package casing 120, because there may be no need to form an opening through the package casing 120 and attach a valve or conventional membrane opening, as a process for manufacturing a casing having a conventional membrane opening typically would require. Another advantage of a package casing 120 having a smooth exterior surface is that because a user can easily clean it or wipe it down, the user may more easily maintain portable devices 105 with such package casings 120.

FIG. 2A is a more detailed end view of the battery package 100, showing an embodiment of the package casing 120 having two or more portions joined at a casing seal 130. The package casing 120 may comprise a variety of plastic materials, e.g., polyvinyl chloride, polyethylene, polymethyl methacrylate and/or other acrylics, silicones, and/or polyurethanes. The casing seal 130 may be an ultrasonic weld or other fastening arrangement that holds the casing body together, creating an internal cavity within the package casing 120. The seal 130 is generally stronger than the casing wall at the dimple 140. The dimple 140 extends a fixed depth into the casing wall and it may be adjacent to one or more of the battery cells 160. The battery cells 160 generally comprise rechargeable chemistries, e.g., lithium-ion, nickel-metal-hydride, nickel-iron, and/or nickel-cadmium.

FIG. 2B is a cross-sectional side view of an embodiment of the battery package 100 showing the package casing 120, the casing seal 130, the dimple 140, the battery cells 160, and package interconnects 180 and package circuitry 190 coupled to the battery cells 160. The package interconnects 180 electrically couple the battery package 100 to the portable device 105 (FIG. 1) and the package circuitry 190 may optionally add power feedback and control functionality to the battery package 100.

FIG. 2C is an isometric view of an interior portion of an embodiment of the package casing 120. The casing 120 can include a casing wall 122 having an interior surface 126 and an exterior surface 128 separated from the interior surface 126 by a thickness t₁. The dimple 140 can be located at the interior surface 126 and can have a diameter width, or cross-sectional dimension d₁ and a fixed depth or height d₂. In particular embodiments, the dimple diameter d₁ and depth d₂ can be inversely proportional to the strength (e.g., shear strength and/or deformation resistance) of the casing wall 122 at the dimple 140. Accordingly, a variety of design considerations may be evaluated to determine an appropriate size of the dimple 140 so that it preferentially ruptures at a preselected pressure and/or in a preselected direction. Such design considerations include the interior volume or interior space of the package casing 120, the casing wall thickness t₁, as well as the presence of other local weak points within the casing 120 (e.g., corners, seal regions, casing defects, and/or other features). In a particular embodiment the casing wall thickness t₁ can be in the range of from about 0.04 inches to about 0.06 inches and the dimple depth d₂ can be in the range of from about 0.005 to about 0.03 inches.

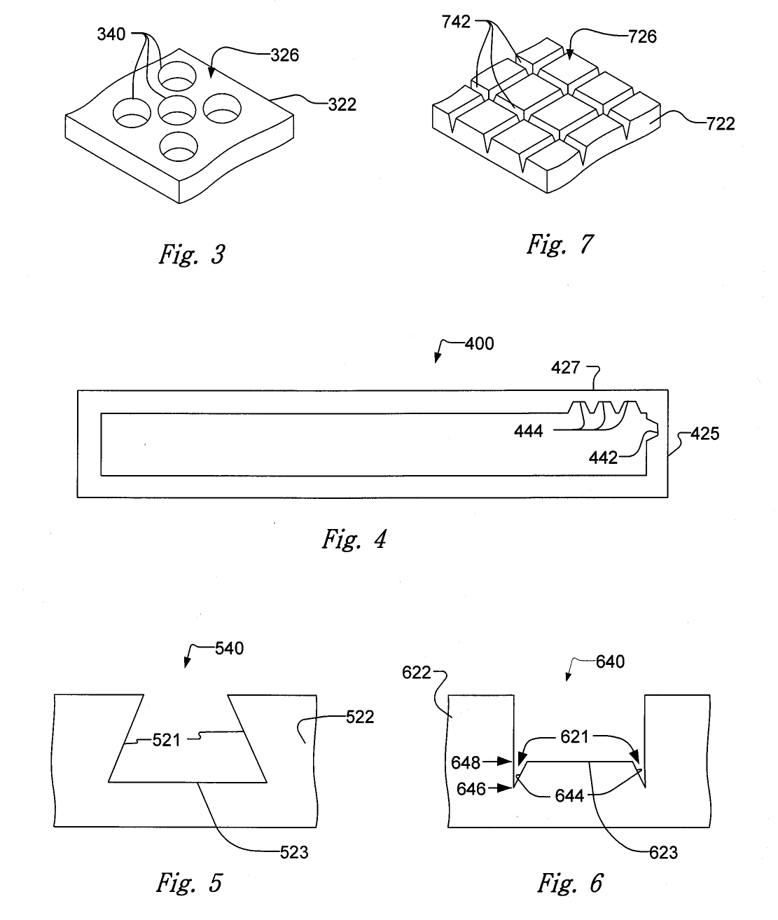

In an embodiment shown in FIG. 2C, the dimple 140 is a single cylindrically shaped hole in the casing wall 122. The dimple 140 includes at least one sidewall 144 extending from an opening 142 in the interior surface to an intermediate section 146 of the casing wall 122. In other embodiments, more than one dimple may be made in the casing wall at one or more locations within the package casing. For example, FIG. 3 is an isometric view of a representative casing wall 322 having an interior surface 326 and a plurality of dimples 340 extending from a plurality of openings (not labeled in FIG. 3) in the interior surface 326 into intermediate sections (not labeled in FIG. 3) of the casing wall 322. At least some of the dimples 340 are proximate to each other. FIG. 4 is a cross-sectional view of a representative package casing 400 having a dimple 442 located at a casing end wall 425 and a plurality of dimples 444 located at a casing top wall 427. The casing end wall 425 and the casing top wall 427 are adjacent to each other. The dimple arrangements of FIGS. 3 and 4 can distribute the gases from a package casing rupture across extended portions of one or more casing walls. This in turn can reduce the escape velocity of the gases, while still keeping the gases away from selected components of the portable device in which the package casing is positioned.

In other embodiments, the dimple may have a base 523 and other shapes or profiles. For example, FIG. 5 is a cross-sectional view of casing wall 522 with a dimple 540 that has a base 523 and sloping surfaces 521 or sidewalls. The sloping surfaces 521 extend to the base 523 by diverging from an opening (not labeled in FIG. 5) to the base 523. The angle of the sloping surfaces 521 may be selected so as to fan out the gases as they are ejected or expelled along the sloping surfaces 521 through a rupture in the casing wall 522 at the dimple 540. As a result, the sloping surfaces 521 can reduce the escape velocity and the density of the gases as they are emitted through a rupture in the casing wall 522 at the dimple 540.

FIG. 6 is a cross-sectional view of a casing wall 622 having a dimple 640 with trench regions 621 formed at a base 623 of the dimple 640. The base 623 has sidewalls 644 that extend by converging forward from an intermediate section 646 of the casing wall to a second intermediate section 648 of the casing wall. It is expected that when the dimple 640 ruptures, the configurations of the trench regions 621 will cause the dimple 640 to rupture completely or partially in a manner that is similar to opening a can of soda. As a result, the base 623 is expected to completely or partially break away from the casing wall 622. The resulting opening and/or deformed base 623 can provide a visible indication that the casing wall 622 has ruptured.

In other embodiments, the dimple can have any of a variety of other types of sharp, angled, curved, or rounded hole-type shapes. Additionally, in lieu of a hole-type shape, a general surface depression may be molded, scribed, keyed, or otherwise formed into the surface of a casing wall. For example, FIG. 7 is an isometric view of a portion of a casing wall 722 having an interior surface 726 that includes a plurality of intersecting grooves 742 or scored notches. The pressure at which the casing wall 722 ruptures can be controlled by controlling the density and/or the depth of the grooves 742. In general, the deeper and/or larger a surface depression is, the easier it is to rupture a package casing at the surface depression.

Dimples, blind holes, and/or other type of surface depressions including those described above can be manufactured using a variety of suitable techniques. For example, in many embodiments, one or more dimples can be designed into a mold that is used for forming the package casing. Accordingly, the dimples are formed concurrently with the package casing. In other embodiments, a dimple can be made in a separate manufacturing step. For example, dimples can be formed using a drill, a stamping tool, a laser, a waterjet, a scribe, or other type of instrument that removes and/or deforms the material forming the casing wall.

From the foregoing, it will be appreciated that specific, representative embodiments have been described herein for purposes of illustration, but that various modifications may be made to these embodiments. For example, the package casings can have characteristics other than those specifically described above, including screws to hold the shell together, a combination of materials other than plastics (e.g., metals), and a shape that is suited to fit within or couple to a particular type of electronic device. The battery packages can also have features other than those described above and shown in the Figures and may also include more or fewer components than those illustrated. For example, in some embodiments the package circuitry may be omitted. In many embodiments a different number of battery cells may be housed in variously sized packages, and in other embodiments the battery cells may comprise non-rechargeable chemistries. While not expressly shown in the Figures, the battery package and corresponding package casing can be coupled to any of a wide variety of portable and stationary electronic devices. While representative examples of pressure release points were described above in the content of dimples, other embodiments may include other types of depressions or features. In addition, the dimples, blind holes, cavities and other surface depressions may be configured in manners other than those specifically shown and described above so that the package casing preferentially ruptures in a manner that mitigates damage to internal components, neighboring devices, or other objects that are within the vicinity of the package casing. Further, while advantages associated with certain embodiments have been described in the context of those embodiments, other embodiments may also exhibit such advantages, and not all embodiments need necessarily exhibit such advantages to fall within the scope of the invention. Accordingly, the invention is not limited except as by the appended claims.

I/We claim:

1. A battery package for providing power to an electronic device, the battery package comprising a casing configured to enclose at least one battery cell, wherein the casing includes a wall having an internal surface, an external surface and a dimple extending outward from the internal surface to an intermediate section of the wall.

2. The battery package of claim 1 wherein the dimple is not visible from the external surface.

3. The battery package of claim 1 wherein the electronic device has an electronic component, and wherein the dimple extends outward in a direction generally facing away from the electronic component.

4. The battery package of claim 1 wherein the dimple is generally cylindrical.

5. The battery package of claim 1 wherein the wall has a thickness of approximately 0.04 inches to approximately 0.06 inches and the dimple has a depth of approximately 0.005 inches to approximately 0.03 inches.

6. The battery package of claim 1 wherein the casing forms an internal volume, the wall has a thickness, the dimple has a depth and a cross-sectional dimension, and wherein at least one of the depth and the cross-sectional dimension are determined based at least partially upon at least one of the internal volume and the wall thickness.

7. The battery package of claim 1 wherein the dimple is a first dimple extending from a first portion of the internal surface to a first intermediate section of the wall, and wherein the casing further includes a second dimple extending from a second portion of the internal surface to a second intermediate section of the wall.

8. The battery package of claim 7 wherein the first and second dimples are proximate to each other.

9. The battery package of claim 1 wherein the wall is a first wall having a first internal surface, a first external surface and a first dimple extending from the first internal surface to a first intermediate section of the first wall, and wherein the casing further includes a second wall having a second internal surface, a second external surface and a second dimple extending from the second internal surface to a second intermediate section of the second wall.

10. The battery package of claim 9 wherein the first and second walls are adjacent to each other.

11. The battery package of claim 1 wherein the dimple includes a sidewall diverging outward from the internal surface to the intermediate section.

12. The battery package of claim 1 wherein the intermediate section is a first intermediate section, and wherein the dimple has a base having a sidewall converging inward from the intermediate section to a second intermediate section of the wall.

13. The battery package of claim 1 wherein the dimple includes at least two sidewalls converging outward from the internal surface to the intermediate section of the wall.

14. A casing for housing at least one battery cell, the casing comprising walls forming an interior space, at least one wall including at least one opening, and a cavity including a sidewall extending outward from the at least one opening to an intermediate section of the at least one wall, wherein the portion of the at least one wall from the intermediate section to an external surface of the casing is configured to rupture when the interior space is subjected to an elevated internal pressure.

15. The casing of claim 14, wherein the sidewall diverges rearward from the at least one opening to the intermediate section of the at least one wall.

16. An electronic device, comprising:
a housing;
an electronic component positioned within the housing; and
a battery package positioned within the housing and electrically coupled to the electronic component, the battery package including a casing enclosing at least one battery cell, wherein the casing includes a wall having an internal surface, an external surface and a dimple extending outward from the internal surface to an intermediate section of the wall, and wherein the dimple extends outward in a direction generally facing away from the electronic component.

17. The electronic device of claim 16, wherein 7 the dimple includes a sidewall diverging outward from the internal surface to the intermediate section

18. A method for manufacturing a battery package casing, the method comprising:
forming at least one blind hole at an interior surface of the battery package casing, wherein the blind hole extends from the interior surface to an intermediate section of the battery package casing;
disposing a battery cell within the battery package casing; and
sealing the battery package casing.

19. The method of claim 18, wherein the blind hole has a depth and a cross-sectional dimension, and wherein forming the at least one blind hole at the interior surface of the battery package casing includes forming the depth and the cross-sectional dimension of the blind hole so as to cause the portion of the battery package casing from the intermediate section to an exterior surface of the battery package casing to rupture when an interior pressure of the battery package casing reaches a preselected pressure.

20. The method of claim 18, further comprising forming the battery package casing, and wherein forming the at least one blind hole at the interior surface of the battery package casing includes forming the at least one blind hole at the interior surface of the battery package casing concurrently with forming the battery package casing.

21. The method of claim 18, further comprising forming the battery package casing, and wherein forming the at least one blind hole at the interior surface of the battery package casing includes removing material from the battery package casing to form the at least one blind hole.

22. The method of claim 18, further comprising forming the battery package casing, and wherein forming the at least one blind hole at the interior surface of the battery package casing includes forming the at least one blind hole without removing material from the battery package casing.

23. The method of claim 18, wherein the blind hole has a depth and a cross-sectional dimension, wherein the portion of the battery package casing between the intermediate section of the wall and an external surface of the battery package casing has a strength, and wherein forming the at least one blind hole at the interior surface of the battery package casing includes selecting at least one of the blind hole depth and the blind hole cross-sectional dimension based at least partially upon an inverse relationship to the strength of the portion of the battery package casing between the intermediate section of the wall and an external surface of the battery package casing.

24. A method for utilizing a battery package casing, the method comprising:
providing a casing having at least one blind hole disposed at an interior surface of the casing, wherein the casing houses a battery; and
equalizing a battery-induced pressure accumulation in the casing by rupturing the casing at the blind hole.

25. The method of claim 24 wherein providing a casing having at least one blind hole includes providing a casing having a blind hole having dimensions configured so as to cause the casing at the blind hole to be the first portion of the casing to rupture when equalizing a battery-induced pressure accumulation in the casing.

26. The method of claim 24 wherein providing a casing having at least one blind hole includes providing a casing having a blind hole having a sidewall diverging from the interior surface to an intermediate section of the casing, and wherein equalizing a battery-induced pressure accumulation in the casing includes expelling accumulated gases in the casing along the diverging sidewall and through the rupture in the casing at the blind hole.

27. The method of claim 24, wherein equalizing a battery-induced pressure accumulation in the casing by rupturing the casing at the blind hole includes preferentially directing accumulated gases in the casing through the rupture in the casing at the blind hole and away from an electronic component of an electronic device to which the battery package casing is operably coupled.
